(19) United States
(12) Patent Application Publication
(10) Pub. No.: US 2026/0346602 A1
(43) Pub. Date: Nov. 5, 2026

(54) RECORDING APPARATUS, RECORDING METHOD, AND NON-TRANSITORY COMPUTER READABLE STORAGE MEDIUM

(71) Applicant: CANON KABUSHIKI KAISHA, Tokyo (JP)

(72) Inventors: YOHEI KOHASHI, Kanagawa (JP); TETSUYA EDAMURA, Tokyo (JP); TORU OHNISHI, Kanagawa (JP); TATSUAKI ORIHARA, Tokyo (JP); AKIRA YAMAMOTO, Kanagawa (JP); KAZUKI NARUMI, Tokyo (JP); YUTARO NAKATSUKA, Kanagawa (JP)

(21) Appl. No.: 19/656,046

(22) Filed: Apr. 23, 2026

(30) Foreign Application Priority Data
May 1, 2025 (JP) 2025-076126

(51) Int. Cl. B41J 2/045; B41J 11/00

(52) U.S. Cl. CPC B41J 2/0454; B41J 2/04566; B41J 11/002

(57) ABSTRACT

A technique of the present disclosure controls the temperature of a recording medium based on a recording environment condition so that an amount of reaction liquid remaining on the recording medium surface during ink application is an appropriate amount, to thereby suppress the occurrence of image unevenness and stably perform high-quality recording. In a recording apparatus, the type of recording medium is determined based on recording medium information that is input, and if it is determined that the recording medium is a low-permeability medium, a recording medium temperature obtained by measurement by a measurement unit is acquired. Based on the acquired recording medium temperature, the recording apparatus decides driving settings for a heating unit (first drying unit) and a cooling unit (first cooling unit), and drives the heating unit and the cooling unit according to the decided driving settings.

### BACKGROUND

### Field of the Technology

The present disclosure relates to a recording technique for performing recording using a reaction liquid and ink.

### Description of the Related Art

Conventionally, inkjet recording apparatuses that form an image on a recording medium by ejecting aqueous ink containing a color material from a recording element are known as a method for forming an image on a recording medium. In some of these recording apparatuses a recording method is employed in which a reaction liquid containing a component that increases the viscosity of the ink is ejected together with the ink, and the color material is fixed to the recording medium by a chemical reaction caused when the reaction liquid and the ink come in contact with each other on the recording medium. When the ink lands on the recording medium, if the amount of reaction liquid remaining on the recording medium surface is insufficient, the aggregation property of the ink will decrease and there is a possibility that the amount of ink fixed to the recording medium will be insufficient, which may cause a reduction in color density or image unevenness or the like, leading to a decrease in image quality. Conversely, if the amount of reaction liquid is excessive, image unevenness may occur due to cracking of the ink film or ink being embedded in the reaction liquid film or the like. Japanese Patent Laid-Open No. 2002-321349 discloses a technique of ensuring that the amount of treatment liquid is neither excessive nor insufficient relative to the ink that is used by varying the ejection amount of a treatment liquid, which is a reaction liquid, according to the type of ink.

### SUMMARY

The present disclosure comprises a recording unit configured to apply ink and a reaction liquid that reacts with the ink to a recording medium to record an image, a measurement unit configured to measure a recording environment condition during recording by the recording unit, and a temperature adjustment unit configured to adjust a temperature of the recording medium according to driving settings corresponding to a measurement result obtained by the measurement unit.

Features of the present disclosure will become apparent from the following description of embodiments with reference to the attached drawings.

### BRIEF DESCRIPTION OF THE DRAWINGS

FIG. 1 is a schematic view illustrating a configuration of a recording apparatus in one embodiment;

FIG. 2A is a schematic view for describing a drying unit and a cooling unit;

FIG. 2B is a schematic view for describing a drying unit and a cooling unit;

FIG. 3 is a block diagram illustrating a configuration example of a recording apparatus and an information processing apparatus in one embodiment;

FIG. 4 is a flowchart illustrating an example of image processing in first and second embodiments;

FIG. 5 is a flowchart illustrating an example of control of a drying unit and a cooling unit during recording in the first embodiment;

FIG. 6 is a table illustrating an example of a settings table for deciding driving settings of a first drying unit and a first cooling unit during recording in the first embodiment;

FIG. 7A is a view illustrating a difference in the permeation behavior of a reaction liquid applied to a recording medium when the temperature or moisture content of the recording medium is different;

FIG. 7B is a view illustrating a difference in the permeation behavior of a reaction liquid applied to a recording medium when the temperature or moisture content of the recording medium is different;

FIG. 8 is a flowchart illustrating an example of control of a first drying unit and a first cooling unit during recording in the second embodiment; and

FIG. 9 is a table illustrating an example of a settings table for deciding driving settings of the first drying unit and the first cooling unit during recording in the second embodiment.

### DESCRIPTION OF THE EMBODIMENTS

The amount of a reaction liquid on a recording medium surface varies depending on the type of recording medium as well as environmental conditions during recording, such as the temperature of the recording medium, the moisture content of the recording medium, and the temperature and humidity inside the recording apparatus. For example, in the case of a recording medium which is easily permeable to liquids, after the reaction liquid lands on the recording medium, the amount of reaction liquid remaining on the recording medium surface decreases over time due to permeation of the reaction liquid into the recording medium and evaporation of the reaction liquid. For this reason, when a reaction liquid of an amount that is decided according to the type of ink is ejected, in some cases the amount of reaction liquid may be excessive or insufficient depending on the environmental conditions during recording.

Therefore, in consideration of the problem described above, an object of the present disclosure is to control the temperature of a recording medium based on a recording environment condition so that the amount of a reaction liquid that reacts with ink on the recording medium is an appropriate amount, to thereby suppress the occurrence of image unevenness and stably perform high-quality recording.

Hereunder, a preferred recording apparatus and system configuration of the present invention are described with reference to the drawings. Note that, constituent elements described in the following embodiments are merely examples, and the configuration and various conditions of an apparatus to which the present invention is applied can be modified or changed as appropriate without departing from the gist of the present invention, and are not limited to those of the following embodiments.

### Recording apparatus

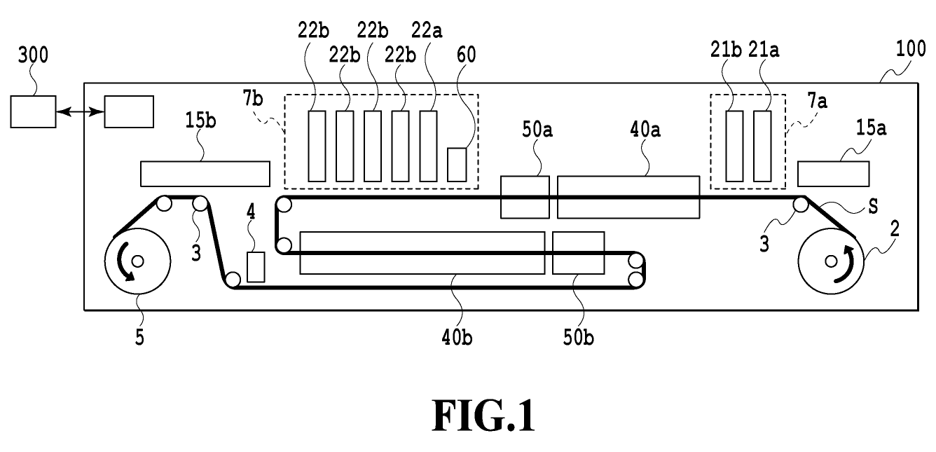

A schematic sectional view illustrating an internal configuration of a recording apparatus 100 is shown in FIG. 1. The recording apparatus 100 of the present example is a high-speed line printer which uses a recording medium S wound in a roll shape. The recording apparatus 100 includes various units, namely, the respective units of an unwinding roll unit 2, a main conveying roller 3, recording units 7a and 7b, a scanner unit 4, a winding roll unit 5, a maintenance unit 15, drying units 40a and 40b, and cooling units 50a and 50b. The recording medium S is conveyed along a recording medium conveyance path indicated by a solid line in FIG. 1, and subjected to processing at each unit.

A recording process performed by the recording apparatus 100 is roughly divided into a first recording process and a second recording process. In the first recording process, an image is recorded on and fixed to the recording medium S through processing performed by a first recording unit 7a, a first drying unit 40a, and a first cooling unit 50a. In the second recording process, by processing performed by a second recording unit 7b, a second drying unit 40b, and a second cooling unit 50b, an image is recorded on and fixed to the recording medium S that underwent the first recording process. In this way, by performing the processing of the first recording process and the second recording process consecutively on the recording medium S, it is possible for the recording apparatus 100 to record an image using a reaction liquid and ink on the recording medium S. Further, it is also possible for the recording apparatus 100 to select and perform only either one of the first recording process and the second recording process according to the recording conditions. Note that, on the recording medium conveyance path and in the conveying process, although not shown in FIG. 1, control for maintaining the tension of the recording medium S at a constant tension, control for correcting an inclination during conveying, and control for maintaining the transfer speed at a constant speed and the like are performed.

The unwinding roll unit 2 is a unit for holding and supplying the recording medium S that is wound into the shape of a roll. The unwinding roll unit 2 is configured to accommodate an unwinding roll, and draw out and supply the recording medium S. Note that, the number of rolls that can be accommodated is not limited to one, and the unwinding roll unit 2 may be configured to accommodate two or three or more rolls and draw out and supply the recording medium S alternately from the rolls. Further, the unwinding roll unit 2 is subjected to rotational control so as to be independently rotated forward and backward by a driving motor (not shown).

The recording unit 7 is a recording medium processing unit that performs recording by applying a liquid composition (ink) onto the recording medium S by means of recording heads 21 and 22 from above the recording medium S that is conveyed. The recording heads 21 and 22 are a plurality of recording heads arranged side by side in the conveyance direction. Further, a measurement unit 60 is provided in the recording unit 7, and the measurement unit 60 is equipped with sensors that measure environmental temperature information and environmental humidity information within and around the recording apparatus 100, or the temperature and moisture content of the recording medium S. Although any type of sensor may be used as long as these desired measurements can be performed, a non-contact type sensor such as an infrared sensor is preferred as a sensor for measuring the temperature or moisture content of the recording medium S.

In the present embodiment, recording heads employing an inkjet method are applied as the recording heads 21 and 22, and more specifically a method using heating elements, a method using piezoelectric elements, a method using electrostatic elements, a method using MEMS elements or the like is used. The first recording unit 7a has a recording head 21a corresponding to a reaction liquid that contains a component that causes an increase in the viscosity of an ink, and a recording head 21b corresponding to W ink. Further, the second recording unit 7b has a recording head 22a corresponding to a reaction liquid, and recording heads 22b corresponding to K (black), Y (yellow), M (magenta), and C (cyan). The reaction liquids and inks are fed to the recording heads 21 and 22 via respective ink tubes from unshown ink tanks. Note that, the types of colors and the number of colors and the number of recording heads 21 and 22 are not limited.

As mentioned above, the reaction liquid is a liquid containing a component that causes an increase in the viscosity of an ink. Here, the phrase "an increase in the viscosity of an ink" refers to a state in which a color material, a resin, or the like constituting the ink comes into contact with the component that causes an increase in the viscosity of the ink, and thereby chemically reacts with or is physically adsorbed to the component, resulting in the occurrence of an increase in the viscosity of the ink. An increase in the viscosity of an ink is not limited to an increase in the overall viscosity of an ink, and also includes a case where a local increase in viscosity occurs due to partial aggregation of a component constituting the ink, such as a color material or a resin. The component that causes an increase in the ink viscosity may be a component such as metal ions or a polymer aggregating agent or the like, and is not particularly limited, and a substance that induces a pH change in ink and causes a color material in the ink to aggregate can be used, or an organic acid can be used. If the reaction liquid is applied to the recording medium S before applying an ink thereto, the ink that reaches the recording medium S can be immediately fixed thereto. This makes it possible to suppress bleeding, which is the mixing together of adjacent inks. Note that, although in the present example ink is applied to the recording medium S using inkjet recording heads, a method for applying ink onto the recording medium S using the recording unit 7 is not particularly limited to this method. For example, although in the present example the reaction liquid is applied by means of the recording head 21, a configuration may be adopted in which the reaction liquid is applied by a roller, a die coating apparatus (die coater), a blade coating apparatus (blade coater), or the like.

The drying units 40 (first drying unit 40a and second drying unit 40b) are units that reduce the liquid content contained in the liquid composition applied to the recording medium S in the recording unit 7, and thereby enhance a fixing property between the recording medium S and the ink. The drying units 40 blow high-temperature air onto the recording medium S on which an image has been recorded, to thereby heat and dry the applied ink. When the recording medium S passes through the inside of the drying units 40, air is blown onto the recording medium S from at least the side of the face on which ink has been applied, to thereby heat and dry the face on which ink has been applied of the recording medium S. The temperature of the air blown by the drying units 40 toward the recording medium S is controlled by a heater unit or the like mounted inside the drying units 40. Note that, as the drying method, apart from adopting a method that blows air, a configuration may also be adopted that combines a method which irradiates electromagnetic waves (ultraviolet rays, infrared rays, or the like) onto the surface of the recording medium S and a conductive heat transfer method that uses contact with a heating device.

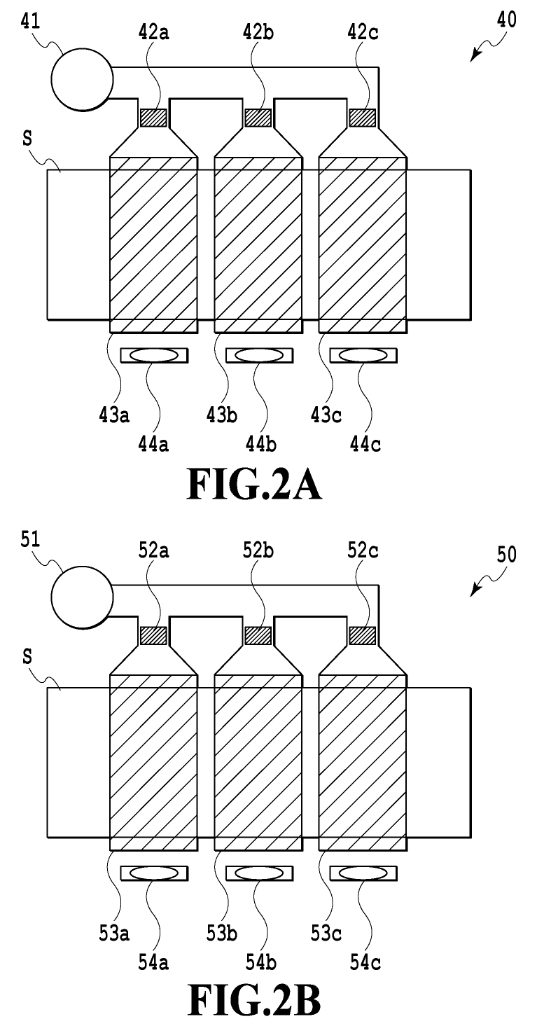

FIG. 2A illustrates one example of the configuration of the drying unit 40. FIG. 2A is a view in which air blowing holes for supplying air to the face on which the reaction liquid and ink have been applied of the recording medium S are seen from the recording medium S side. In other words, FIG. 2A is a view in which an air blowing nozzle surface is seen through the recording medium S from the side on which the reaction liquid and ink have not been applied of the recording medium S. The drying unit 40 includes an air blower 41 as an airflow generating source. An airflow generating generated by the air blower 41 passes through a heater unit 42 where the temperature of the air is adjusted to become a high temperature, and the air is then fed to a nozzle housing 43 having air blowing holes for blowing the air onto the recording medium S. The air blown from the nozzle housing onto the recording medium S is discharged to outside of the drying unit 40 through an exhaust port 44. The example illustrated in FIG. 2A has three nozzle housings 43a, 43b, and 43c as the nozzle housing 43, has heater units 42a, 42b, and 42c corresponding to the three nozzle housings 43a, 43b, and 43c, respectively, and also has exhaust units 44a, 44b, and 44c corresponding to the three nozzle housings 43a, 43b, and 43c, respectively. As the air blowing holes of the nozzle housing 43, a plurality of round holes with a small diameter (diameter of 1.5 mm to 5.0 mm) are formed at regular intervals, and are configured so that air is uniformly blown out from the round holes. Note that, the hole shape adopted for the air blowing holes of the nozzle housing 43 is not limited to a round shape, and a configuration may be adopted in which the air blowing holes are linear slit holes or oval holes or the like, or include a combination of these holes.

The cooling units 50 (first cooling unit 50a and second cooling unit 50b) cool the recording medium S on which the ink was fixed in the drying units 40, to thereby cause the ink to solidify. When the recording medium S passes through the inside of the cooling units 50, air that is at a lower temperature than the temperature of the recording medium S is blown onto the recording medium S from at least the side of the face on which ink has been applied to the recording medium S, to thereby cool the face on which ink has been applied of the recording medium S. With respect to the temperature of the air which the cooling units 50 blow toward the recording medium S, a method may be adopted in which air is taken in from outside the apparatus and emitted toward the recording medium S without controlling the temperature of the air, or the temperature of the air may be controlled by a cooling member or the like mounted inside the cooling units 50. Note that, the cooling method is not limited to a method that blows air, and a conductive heat transfer method that uses contact with a heat-dissipating member may be adopted, or a combination of these methods may be adopted.

FIG. 2B illustrates an example of the configuration of the cooling unit 50. FIG. 2B is a view of the cooling unit 50, in which air blowing holes for supplying air to the face to which the reaction liquid and ink have been applied of the recording medium S are seen from the recording medium S side. In other words, FIG. 2B is a view in which an air blowing nozzle surface is seen through the recording medium S from the side on which the reaction liquid and ink have not been applied of the recording medium S. The cooling unit 50 includes an air blower 51 as an airflow generating source. An airflow generated by the air blower 51 passes through a cooling member 52 where the temperature of the air is adjusted to become a low temperature, and the air is then fed to a nozzle housing 53 having air blowing holes for blowing the air onto the recording medium S. The air blown from the nozzle housing onto the recording medium S is discharged to outside of the cooling unit 50 through an exhaust port 54. The example illustrated in FIG. 2B has three nozzle housings 53a, 53b, and 53c as the nozzle housing 53, has cooling members 52a, 52b, and 52c corresponding to the three nozzle housings 53a, 53b, and 53c, respectively, and also has exhaust units 54a, 54b, and 54c corresponding to the three nozzle housings 53a, 53b, and 53c, respectively. As the air blowing holes of the nozzle housing 53, a plurality of round holes with a small diameter (diameter of 1.5 mm to 5.0 mm) are formed at regular intervals, and are configured so that air is uniformly blown out from the round holes. Note that, the hole shape adopted for the air blowing holes of the nozzle housing 53 is not limited to a round shape, and a configuration may be adopted in which the air blowing holes are linear slit holes or oval holes or the like, or include a combination of these holes. Further, with regard to the cooling unit 50, a configuration may be adopted in which the cooling member 52 is not provided and the cooling unit 50 is configured to blow air generated by the air blower 51 without adjusting the temperature of the air.

Note that, even in a case where application of a liquid composition onto the recording medium S is not performed in the recording unit 7a, the first drying unit 40a and the first cooling unit 50a can heat the recording medium S by blowing air or cool the recording medium S by blowing air as a pre-treatment for recording in the recording unit 7b.

The scanner unit 4 is a unit utilized to read a test image formed on the recording medium S by the recording unit 7 before the main recording, and detect image deviations and density and make corrections for the main recording.

The winding roll unit 5 is a unit for winding the recording medium S that has undergone the recording processing around a winding core. The number of rolls that can be collected is not limited to one, and a configuration may be adopted in which the winding roll unit 5 has two or three or more winding cores and alternately switches between the winding cores to collect the recording medium S.

The maintenance unit 15 is a unit that includes a mechanism for restoring the discharge performance of the recording heads 21 and 22. Examples of such a mechanism include a cap mechanism for protecting the ink discharge surface of the recording heads 21 and 22, a wiper mechanism for wiping the ink discharge surface, and a suction mechanism for suctioning ink inside the recording head 21 and 22 from the ink discharge surface with negative pressure. The maintenance unit also includes an unshown drive mechanism and rails, and is capable of reciprocally moving horizontally along the rails. When performing maintenance of a recording head, the maintenance unit moves to a position directly below the recording head, and when a maintenance operation is not being performed, the maintenance unit moves to a position that is away from a position directly below the recording head. In the present example, a first maintenance unit 15a and a second maintenance unit 15b are provided to correspond with the first recording unit 7a and the second recording unit 7b, respectively.

### System configuration

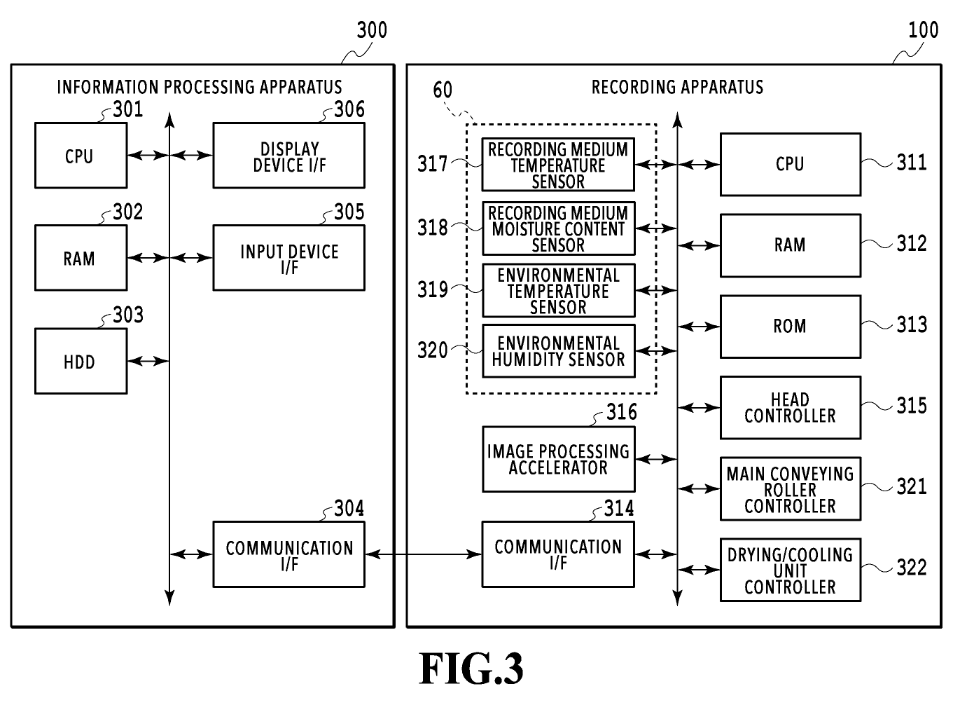

FIG. 3 is a block diagram illustrating an example of the overall configuration of a system that includes the recording apparatus 100 according to the present embodiment. As illustrated in FIG. 3, the system according to the present embodiment is constituted by the recording apparatus 100 illustrated in FIG. 1, and an information processing apparatus (a PC or the like) 300 as a host apparatus for the recording apparatus 100.

The information processing apparatus 300 includes a CPU 301, a RAM 302, a HDD (Hard Disk Drive) 303, a communication I/F 304, an input device I/F 305, and a display device I/F 306. The respective functional units that the information processing apparatus 300 has are communicably connected with each other by an internal bus. The CPU 301 executes processing in accordance with programs and various kinds of data held in the HDD 303 or the RAM 302. The RAM 302 is a volatile storage, and temporarily holds programs and data. The HDD 303 is a nonvolatile storage, and stores programs and data.

The communication I/F 304 is an interface that controls communication with external apparatuses, and in this example the communication I/F 304 controls data transmission and reception with the recording apparatus 100. Here, a wired connection such as a USB connection, an IEEE 1394 connection, or a local area network (LAN) connection, or a wireless connection such as a Bluetooth (registered trademark) connection or a WiFi (registered trademark) connection can be used as a connection method for the data transmission and reception. The input device I/F 305 is an interface for controlling a HID (human interface device), such as a keyboard or a mouse, and receives inputs from a user via an input device. The display device I/F 306 controls the display on a display device such as a display (not shown).

Here, although the following description is based on the assumption that the information processing apparatus 300 is a separate apparatus from the recording apparatus 100, the implementation mode for these apparatuses is not particularly limited as long as the same processing can be performed. For example, the information processing apparatus 300 may be an apparatus that is built into the recording apparatus 100, or may be a server connected to the recording apparatus 100 via a network. Furthermore, for example, the information processing apparatus 300 may be a portable terminal such as a smartphone, a tablet terminal, or an image capturing apparatus.

The recording apparatus 100 includes a CPU 311, a RAM 312, a ROM 313, a communication I/F 314, a head controller 315, and an image processing accelerator 316. In addition, the respective functional units that the recording apparatus 100 has are communicably connected with each other by an internal bus. The CPU 311 executes processing relating to each embodiment described later in accordance with programs and various kinds of data held in the ROM 313 or the RAM 312. The RAM 312 is a volatile storage, and temporarily holds programs and data. The ROM 313 is a nonvolatile storage, and stores various data such as table data and programs used in processing that is described later.

The communication I/F 314 is an interface that controls communication with external apparatuses, and in this example the communication I/F 314 controls data transmission and reception with the information processing apparatus 300. The head controller 315 performs control of the recording heads 21 and 22 illustrated in FIG. 1 based on image formation data. Specifically, the head controller 315 can be configured to read control parameters and image formation data from predetermined addresses in the RAM 312.

When the CPU 311 writes the control parameters and the image formation data to predetermined addresses of the RAM 312, recording processing is started by the head controller 315, and ink ejection operations are performed by the recording heads 21 and 22. The image processing accelerator 316 is constituted by hardware, and can execute image processing faster than the CPU 311. Specifically, the image processing accelerator 316 may be configured to read parameters and data required for the image processing from predetermined addresses of the RAM 312. Here, when the CPU 311 writes parameters and data required for the image processing to predetermined addresses of the RAM 312, the image processing accelerator 316 is activated and predetermined image processing is performed. Note that, the image processing accelerator 316 is not necessarily an essential element, and depending on the specifications and the like of the recording apparatus 100, image processing may be executed only by the processing of the CPU 311.

### FIRST EMBODIMENT

Hereunder, a recording method according to a first embodiment is described. In the present embodiment, the recording apparatus 100 has the recording head 21a corresponding to a reaction liquid for white (W) ink, and the recording head 21b corresponding to W ink. Further, the recording apparatus 100 has the recording head 22a corresponding to a reaction liquid for chromatic color inks, and the recording heads 22b corresponding to color (black (K), cyan (C), magenta (M), and yellow (Y)) inks. In a case where data for W is present in the image data to be recorded, the recording apparatus 100 first performs application of a reaction liquid and W ink to the recording medium S using the recording head 21a corresponding to the reaction liquid for W ink and the recording head 21b corresponding to W ink. After application of the reaction liquid and the W ink, the recording apparatus 100 drives the drying unit 40a and the cooling unit 50a to perform fixing of the W ink to the recording medium S. Next, the recording apparatus 100 performs application of ink to the recording medium S using the recording head 22a corresponding to the reaction liquid for chromatic color ink and the recording heads 22b corresponding to the chromatic color ink. The recording apparatus 100 then drives the drying unit 40b and the cooling unit 50b to perform fixing of the ink to the recording medium S. On the other hand, if data for W is not present in the image data, the recording apparatus 100 performs application of the reaction liquid and the chromatic color ink to the recording medium S using only the recording head 22a and the recording heads 22b, and drives the drying unit 40b and the cooling unit 50b to perform fixing of the chromatic color ink to the recording medium S. In addition to this, in a case where the recording medium S is a low-permeability medium, before performing application of ink to the recording medium S, driving of the drying unit 40a or the cooling unit 50a is performed as a heating unit or a cooling unit that can perform heating or cooling with respect to the recording medium S. The heating unit (drying unit 40a) adjusts the heating temperature by means of the heater unit 42.

The measurement unit 60 is equipped with a recording medium temperature sensor that utilizes two-point projection of a visible light laser that can acquire temperature information of the recording medium S.

The present embodiment is a recording technique for a case where W data is not included in an image to be recorded, and recording is performed using only chromatic color ink and a reaction liquid for chromatic color ink, and without using W ink and a reaction liquid for W ink. Further, in the present embodiment, although the recording unit 7a is not driven, the first drying unit 40a and the first cooling unit 50a are appropriately driven and are utilized as a heating unit and a cooling unit (temperature adjustment units), respectively, for performing heating and cooling with respect to the recording medium S before recording by the recording unit 7b. In the present embodiment, temperature adjustment control with respect to the recording medium S is carried out using the first drying unit 40a and the first cooling unit 50a, and the settings for the temperature adjustment control are changed according to a recording medium temperature that is obtained by measuring recording environment conditions during recording.

When performing recording in the recording apparatus 100, in addition to the image data to be recorded, the user also transmits recording medium information from the information processing apparatus 300 to the recording apparatus 100. Based on the received image data and recording medium information, the recording apparatus 100 performs image processing for generating image formation data for controlling the recording heads 22. When performing this image processing, the CPU 311 or the image processing accelerator 316 inside the recording apparatus 100 reads parameters and data required for image processing according to the received recording medium information from predetermined addresses in the RAM 312.

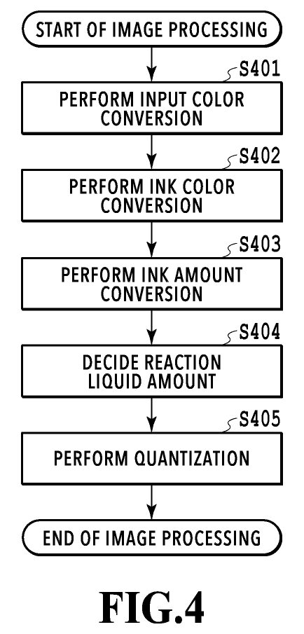

A flowchart for describing image processing performed by the recording apparatus 100 according to the present embodiment is shown in FIG. 4.

In S401, the recording apparatus 100 converts input image data received from the information processing apparatus 300 to image data corresponding to the color gamut of the recording apparatus 100. In the present embodiment, it is assumed that the input image data is data indicating color coordinates (R, G, B) in a color space coordinate system such as sRGB that are colors for representation of a monitor, and the value of each color component is expressed in 8 bits. The recording apparatus 100 according to the present embodiment converts the RGB input image data into image data (R', G', B') corresponding to the color gamut of the recording apparatus 100 by a known method such as matrix computation processing or processing using a three-dimensional lookup table (3D LUT). In the present embodiment, a 3D LUT is used, and conversion processing is performed by combining use of the 3D LUT with interpolation calculations. Further, the format of the input image data is not limited to the aforementioned format, and for example, input image data in the CMYK format can also be used, and in such case conversion of the input image data can be performed by processing using a four-dimensional LUT or the like.

In S402, the recording apparatus 100 converts the RGB image data processed in S401 into image data corresponding to color signal data for the chromatic color inks used in the recording apparatus 100. In the present embodiment, because inks for the colors K, C, M, and Y are used, the image data of the RGB signals is converted into image data composed of 8-bit color signals for each of the colors K, C, M, and Y. Similarly to the processing in S401, it is possible to perform the color conversion processing in S402 by using interpolation calculations in combination with the 3D LUT. Note that, as another conversion method, similarly to S401, a method such as matrix computation processing may be used. Further, although the four colors of K, C, M, and Y are mentioned as an example of the number of inks, other inks may be additionally included, and some of the aforementioned inks do not have to be used.

In S403, the recording apparatus 100 converts the image data consisting of data for CMYK color signals into ink ejection signals that have been corrected so as to correspond to the number of dots used during recording. An arbitrary method can be adopted as the method for converting into ink ejection signals, such as a method that performs gamma adjustment using a one-dimensional LUT. Here, it is assumed that the ink ejection signal is information indicating the ejection amount of the ink during recording.

In S404, the recording apparatus 100 decides a reaction liquid ejection signal based on the ink ejection signals for each ink color processed in the ink amount conversion processing in S403.

In S405, the recording apparatus 100 performs quantization processing with respect to the reaction liquid ejection signal and K, C, M, and Y that are the ink ejection signals for the chromatic color inks, and then ends the image processing. There are various quantization levels available for the quantization processing, such as binary quantization, or ternary quantization to quantization to 16 levels. In general, when binarization processing is performed, a reaction liquid ejection signal P and ink ejection signals K, C, M, and Y for the chromatic color inks are converted into 1-bit data for each of P, K, C, M, and Y that indicates whether or not to perform ejection. A known pseudo-halftone processing method such as a dither matrix method or an error diffusion method may be used as the quantization processing method.

After the image processing in S401 to S405, when recording is started, the CPU 311 controls a main conveying roller controller 321 to drive the main conveying roller 3 to perform conveying of the recording medium S. Further, the CPU 311 controls a drying/cooling unit controller 322 to drive the drying units 40 and the cooling units 50, and also controls the head controller 315 to drive the recording heads 22 to perform recording. The measurement unit 60 acquires temperature information with respect to the recording medium S at regular time intervals during recording.

Hereunder, the details of the method for controlling the heating unit (first drying unit 40a) and the cooling unit (first cooling unit 50a) during recording that is a feature of the present embodiment are described.

Here, the permeability of the recording medium will be described. As an example of a method for evaluating the permeability of the recording medium, Bristow's method described in "Method for determining the liquid absorbability of paper and board" in JAPAN TAPPI Paper Pulp Test Method No. 51 can be used. Hereunder, the measurement method using Bristow's method is briefly described.

First, a predetermined amount of ink is injected into a holding container having an opening slit of a predetermined size, and through the slit, the ink is brought into contact with a recording medium that has been processed to have a strip shape and wound around a disk. Next, the disk is rotated while keeping the holding container fixed in position, and the area (length) of an ink band transferred to the recording medium is measured. The transfer amount (ml/m⁻²) per second per unit area can be calculated based on the area of the ink band. In the present embodiment, a recording medium for which the transfer amount (absorption amount) of ink at 30 msec^{1/2} measured using Bristow's method is less than 10 ml/m⁻² is regarded as a recording medium that has low permeability (a non-permeable recording medium).

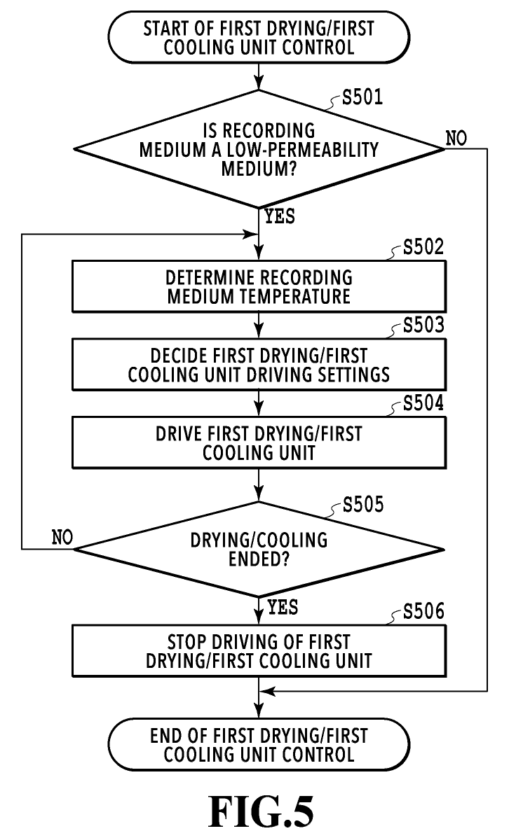

A flowchart for describing control of the heating unit (first drying unit 40a) and the cooling unit (first cooling unit 50a) that the recording apparatus 100 according to the present embodiment performs during recording is shown in FIG. 5.

In S501, the recording apparatus 100 determines the type of recording medium S based on the recording medium information that was input. Depending on the type of recording medium S that is determined here, the recording apparatus 100 decides whether or not to execute the processing of the following S502 to S506. If it is determined that the recording medium S is a low-permeability medium, the recording apparatus 100 performs the processing of the following S502 to S506. If it is determined that the recording medium S is not a low-permeability medium, the recording apparatus 100 does not perform the processing of S502 to S506, and does not drive the heating unit (first drying unit 40a) and the cooling unit (first cooling unit 50a) during recording.

In S502, the recording apparatus 100 acquires information relating to a recording environment condition obtained by measurement by the measurement unit 60. Here, an example is described in which the temperature of the recording medium S measured by a recording medium temperature sensor 317 included in the measurement unit 60 is acquired.

In S503, the recording apparatus 100 decides driving settings for the heating unit (first drying unit 40a) and the cooling unit (first cooling unit 50a) based on the recording medium temperature acquired in S502. The driving settings for the heating unit (first drying unit 40a) and the cooling unit (first cooling unit 50a) refer to, specifically, the set temperature when the heating unit is driven, that is, the heating temperature, and whether or not driving of the cooling unit is to be performed. In the present embodiment, the driving settings for the heating unit (first drying unit 40a) and the cooling unit (first cooling unit 50a) are decided by the recording apparatus 100 selecting driving settings corresponding to the acquired recording medium temperature, from a driving settings table stored in the ROM 313.

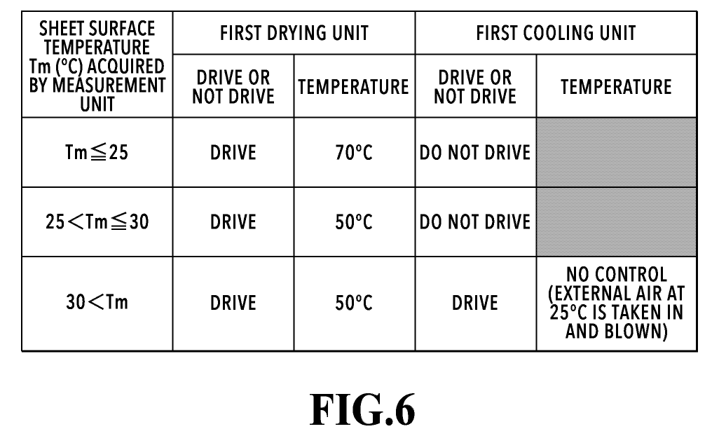

FIG. 6 shows an example of a driving settings table for the heating unit (first drying unit 40a) and the cooling unit (first cooling unit 50a) in the present embodiment. Here, 25° C (first threshold value) and 30° C (second threshold value) are set as threshold values for the temperature of the recording medium S at which the drive settings that are selected are switched. If a recording medium temperature Tm acquired in S502 is equal to or lower than the first threshold value, that is, is equal to or lower than 25° C, the heating temperature of the heating unit (first drying unit 40a) is set to 70° C and the cooling unit (first cooling unit 50a) is not driven. If the recording medium temperature Tm is higher than the first threshold value and equal to or lower than the second threshold value, that is, is higher than 25° C and equal to or lower than 30° C, the heating temperature of the heating unit (first drying unit 40a) is set to 50° C and the cooling unit (first cooling unit 50a) is not driven. If the recording medium temperature Tm is higher than the second threshold value, that is, is higher than 30° C, the heating temperature of the heating unit (first drying unit 40a) is set to 50° C and the cooling unit (first cooling unit 50a) is driven. Note that, when the cooling unit (first cooling unit 50a) is driven, temperature control of the cooling unit (first cooling unit 50a) is not performed, and external air (approximately 25° C) that is outside the recording apparatus 100 is taken in and blown at the recording medium S to cool the recording medium S.

In S504, the recording apparatus 100 drives the heating unit (first drying unit 40a) and the cooling unit (first cooling unit 50a) according to the driving settings decided in S503. Thus, by performing control for heating or cooling to increase or decrease the temperature of the recording medium before recording with chromatic color ink, the temperature of the recording medium S when applying the reaction liquid for the chromatic color ink is maintained within a predetermined temperature range, thereby enabling stable performance of high-quality recording.

In S505, the recording apparatus 100 determines whether to stop or to continue driving of the heating unit (first drying unit 40a) and the cooling unit (first cooling unit 50a). If recording operations, specifically, driving of the recording unit 7b or conveying of the recording medium S by the unwinding roll unit 2 and the winding roll unit 5 is continuing, the recording apparatus 100 continues driving the heating unit (first drying unit 40a) and the cooling unit (first cooling unit 50a). This determination is performed at regular time intervals during recording. If the recording operations have ended, the process transitions to S506 in which the recording apparatus 100 performs processing to stop driving of the heating unit (first drying unit 40a) and the cooling unit (first cooling unit 50a). If the recording operations are continuing, the process returns to S502 in which the recording apparatus 100 acquires the recording medium temperature and changes the driving settings for the heating unit (first drying unit 40a) and the cooling unit (first cooling unit 50a) in accordance with the acquired recording medium temperature, and continues driving the heating unit (first drying unit 40a) and the cooling unit (first cooling unit 50a).

In this way, by performing temperature adjustment control with respect to the recording medium according to a measured value of a recording environment condition that is a measurement result obtained by the measurement unit 60, which in the present embodiment is the recording medium temperature, the temperature and moisture content of the recording medium can be adjusted when performing recording using the recording unit 7b. Thus, when a reaction liquid has been applied to the recording medium, the amount of reaction liquid that remains on the recording medium surface can be stably made an appropriate amount.

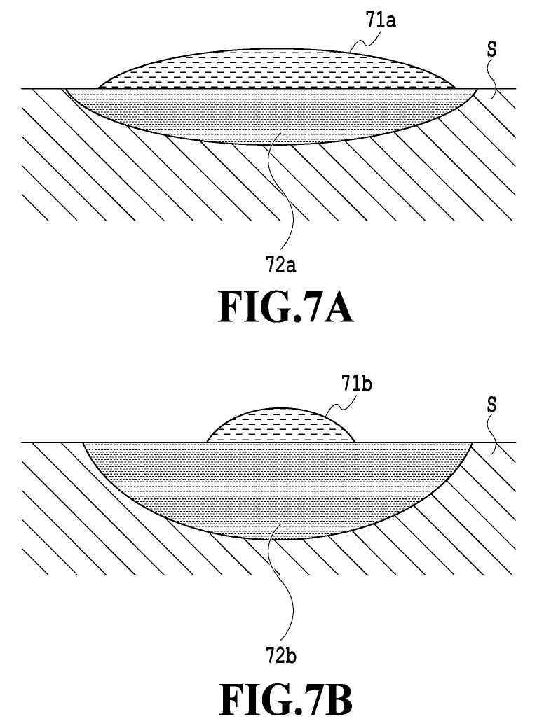

Here, the manner in which the permeation speed of the reaction liquid applied to the recording medium S changes when the temperature of the recording medium S conveyed through the inside of the recording apparatus 100 changed due to a change in the installation environment of the recording apparatus 100 or due to continuous operation of the recording apparatus 100 or the like is illustrated in FIG. 7. The state illustrated in FIG. 7A corresponds to a case where the recording medium temperature is low, and the state illustrated in FIG. 7B corresponds to a case where the recording medium temperature is higher. A reaction liquid 71 indicates the reaction liquid that remains on the recording medium S, and a reaction liquid 72 indicates the reaction liquid that has permeated into the recording medium S. Of the total amount of reaction liquid applied onto the recording medium S, with respect to the amount of reaction liquid 71 that remains on the recording medium S, an amount of reaction liquid 71a in the case where the recording medium temperature is low is greater than an amount of reaction liquid 71b in the case where the recording medium temperature is high. On the other hand, with respect to amount of reaction liquid 72 that permeates into the recording medium S, the amount of a reaction liquid 72a in the case where the recording medium temperature is low is less than the amount of a reaction liquid 72b in the case where the recording medium temperature is high. Due to the amount of reaction liquid that remains on the sheet surface during chromatic color ink application changing significantly depending on the recording medium temperature in this way, the aggregation property of the chromatic color ink varies significantly, which makes it difficult to stably perform high image quality recording. On the other hand, in the present embodiment, by performing control for stabilizing the temperature of the recording medium S before the recording unit 7b when executing recording, changes in the amount of reaction liquid remaining on the recording medium S are suppressed and thus the aggregation property of the chromatic color ink is maintained within an appropriate range to thereby enable stable performance of high-quality recording.

Note that, although in the first embodiment the recording medium temperature measured by the measurement unit 60 is fed back, a measured value of a recording environment condition is not limited to the recording medium temperature, and multiple other measured values such as the temperature and moisture content of the recording medium S may be used. By this means, a more detailed reaction liquid application amount table can be prepared, and hence the reaction liquid application amount can be controlled more precisely with respect to a change in the recording environment conditions.

Although in the above description an example is described in which recording medium information is input when performing recording, it is also conceivable that a case may arise in which a recording medium S that has not been registered in the recording apparatus 100 is used. In such a case, other means may be adopted such as having the user select similar recording medium information, having the user input only information indicating whether the recording medium S is a permeable recording medium or a non-permeable recording medium, or having the user select whether or not to perform temperature adjustment control based on information from the measurement unit 60.

### SECOND EMBODIMENT

In the second embodiment, in a case where the recording medium S is a low-permeability medium, the drying unit 40a or the cooling unit 50a are used to perform drying or cooling of the recording medium S before application of ink to the recording medium S.

In the present embodiment, the measurement unit 60 acquires the environmental humidity as a measured value of a recording environment condition using an environmental humidity sensor 320 that can acquire humidity information with respect to the recording unit 7b. When the environmental humidity acquired by the measurement unit 60 is high, the moisture content of the recording medium S is high as compared to a time when the environmental humidity is low, and consequently the permeability of the reaction liquid into the recording medium S decreases.

Similarly to the first embodiment, the present embodiment is a recording technique for a case where W data is not included in an image to be recorded, and recording is performed using only chromatic color inks and a reaction liquid for chromatic color inks, and without using W ink and a reaction liquid for W ink. In the present embodiment also, although, similarly to the first embodiment, the recording unit 7a is not driven, the first drying unit 40a and the first cooling unit 50a are driven and utilized as a heating unit and a cooling unit (temperature adjustment units) for performing heating and cooling with respect to the recording medium S before recording by the recording unit 7b. In the present embodiment, temperature adjustment control with respect to the recording medium S is carried out using the first drying unit 40a and the first cooling unit 50a, and the settings for the temperature adjustment control are changed according to the environmental humidity that is obtained by measuring an environmental condition during recording.

Note that, in the present embodiment also, similarly to the first embodiment, the flow of image processing when performing recording is performed according to the flow illustrated in FIG. 4.

After the image processing in S401 to S405, when recording is started, the CPU 311 controls a main conveying roller controller 321 to drive the main conveying roller 3 to perform conveying of the recording medium S. Further, the CPU 311 controls the drying/cooling unit controller 322 to drive the drying units 40 and the cooling units 50, and also controls the head controller 315 to drive the recording heads 22 to perform recording. The measurement unit 60 acquires humidity information with respect to the recording unit 7b at regular time intervals during recording.

Hereunder, the details of the method for controlling the heating unit (first drying unit 40a) and the cooling unit (first cooling unit 50a) during recording that is a feature of the present embodiment are described.

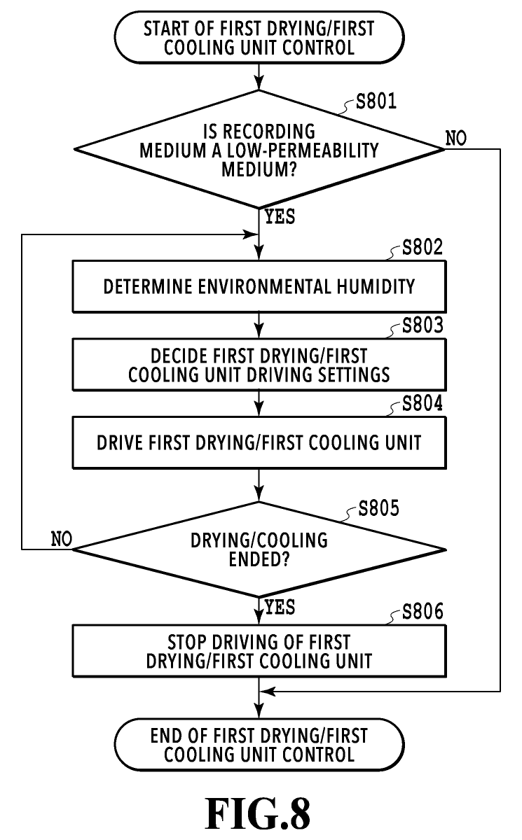

A flowchart for describing control of the heating unit (first drying unit 40a) and the cooling unit (first cooling unit 50a) that the recording apparatus 100 according to the present embodiment performs during recording is shown in FIG. 8.

In S801, the recording apparatus 100 determines the type of recording medium S based on the recording medium information that was input. Depending on the type of recording medium S that is determined here, the recording apparatus 100 decides whether or not to execute the processing of the following S802 to S806. If it is determined that the recording medium S is a low-permeability medium, the recording apparatus 100 performs the processing of the following S802 to S806. If it is determined that the recording medium S is not a low-permeability medium, the recording apparatus 100 does not perform the processing of S802 to S806, and does not drive the heating unit (first drying unit 40a) and the cooling unit (first cooling unit 50a) during recording.

In S802, the recording apparatus 100 acquires information relating to a recording environment condition obtained by measurement by the measurement unit 60. Here, an example is described in which the value of the environmental humidity sensor 320 included in the measurement unit 60 is acquired.

In S803, the recording apparatus 100 decides driving settings for the heating unit (first drying unit 40a) and the cooling unit (first cooling unit 50a) based on the value of the environmental humidity sensor 320, that is, the environmental humidity, acquired in S802. The driving settings for the heating unit (first drying unit 40a) and the cooling unit (first cooling unit 50a) refer to, specifically, with respect to a predetermined environmental humidity, whether or not driving is to be performed and, if so, the temperature setting during driving, that is, the setting for the heating temperature or the cooling temperature. In the present embodiment, the driving settings for the heating unit (first drying unit 40a) and the cooling unit (first cooling unit 50a) are decided by the recording apparatus 100 selecting driving settings corresponding to the acquired environmental humidity from a driving settings table stored in the ROM 313.

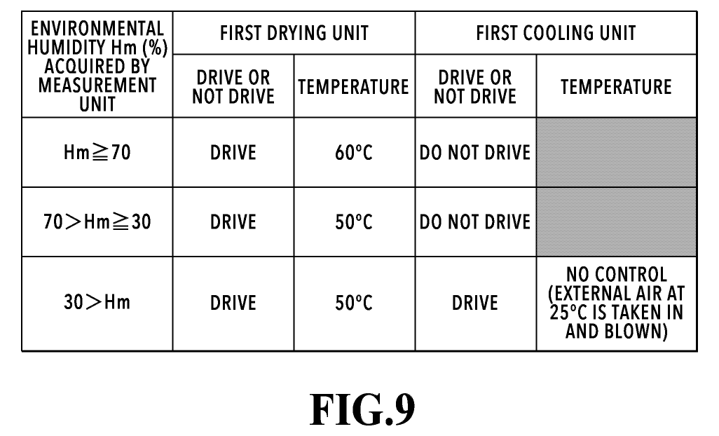

FIG. 9 shows an example of a driving settings table for the heating unit (first drying unit 40a) and the cooling unit (first cooling unit 50a) in the present embodiment. Here, relative humidity values of 30 % (first threshold value) and 70 % (second threshold value) are set as threshold values for the environmental humidity at which the drive settings that are selected are switched. If an environmental humidity Hm detected by the measurement unit 60 is equal to or greater than the second threshold value, that is, is equal to or greater than 70 %, the heating temperature of the heating unit (first drying unit 40a) is set to 60° C and the cooling unit (first cooling unit 50a) is not driven. If the environmental humidity Hm detected by the measurement unit 60 is higher than the first threshold value and less than the second threshold value, that is, is higher than 30 % and less than 70 %, the heating temperature of the heating unit (first drying unit 40a) is set to 50° C and the cooling unit (first cooling unit 50a) is not driven. If the environmental humidity Hm detected by the measurement unit 60 is less than the first threshold value, that is, is less than 30 %, the heating temperature of the heating unit (first drying unit 40a) is set to 50° C and the cooling unit (first cooling unit 50a) is driven. Note that, when driving the cooling unit (first cooling unit 50a), temperature control of the cooling unit (first cooling unit 50a) is not performed, and external air (approximately 25° C) that is outside the recording apparatus 100 is taken in and blown at the recording medium S to cool the recording medium S.

In S804, the recording apparatus 100 drives the heating unit (first drying unit 40a) and the cooling unit (first cooling unit 50a) according to the driving settings decided in S803. Thus, by performing control for heating or cooling to increase or decrease the temperature of the recording medium before recording with chromatic color ink, it is possible to always maintain a predetermined state with respect to permeation of a liquid into the recording medium S, thereby enabling stable performance of high-quality recording.

In S805, the recording apparatus 100 determines whether to stop or to continue driving of the heating unit (first drying unit 40a) and the cooling unit (first cooling unit 50a). If recording operations, specifically, driving of the recording unit 7b or conveying of the recording medium S by the unwinding roll unit 2 and the winding roll unit 5 is continuing, the recording apparatus 100 continues driving the heating unit (first drying unit 40a) and the cooling unit (first cooling unit 50a). This determination is performed at regular time intervals during recording. If the recording operations have ended, the process transitions to S806 in which the recording apparatus 100 performs processing to stop driving of the heating unit (first drying unit 40a) and the cooling unit (first cooling unit 50a). If recording operations are continuing, the process returns to S802 in which the recording apparatus 100 determines the environmental humidity and changes the driving settings for the heating unit (first drying unit 40a) and the cooling unit (first cooling unit 50a), and continues driving the heating unit (first drying unit 40a) and the cooling unit (first cooling unit 50a).

In the present embodiment, during recording using the recording unit 7b, the driving settings for the heating unit (first drying unit 40a) and the cooling unit (first cooling unit 50a) that are located before the recording unit 7b are changed according to the environmental humidity that is a recording environment condition measured by the measurement unit 60. In this way, by changing the driving settings for the heating unit and the cooling unit with respect to the recording medium S and changing an air blowing condition, that is, the heating temperature or cooling temperature, the temperature and moisture content of the recording medium S in the recording unit 7b when recording is executed can be adjusted.

When the moisture content of the recording medium S inside the recording apparatus 100 changed due to a change in the installation environment of the recording apparatus 100 or due to continuous operation of the recording apparatus 100 or the like, the permeation speed of the reaction liquid that was applied to the recording medium S also changes. The state illustrated in FIG. 7A corresponds to a case where the moisture content of the recording medium S is high, and the state illustrated in FIG. 7B corresponds to a case where the moisture content of the recording medium S is low. Of the total amount of reaction liquid applied onto the recording medium S, with respect to the amount of reaction liquid 71 that remains on the recording medium S, the amount of reaction liquid 71a in the case where the moisture content of the recording medium S is high is greater than the amount of reaction liquid 71b in the case where the moisture content of the recording medium S is low. On the other hand, with respect to the amount of reaction liquid 72 that permeates into the recording medium S, the amount of reaction liquid 72b in the case where the moisture content of the recording medium S is low is greater than the amount of reaction liquid 72a in the case where the moisture content of the recording medium S is high. Due to the amount of reaction liquid that remains on the sheet surface during chromatic color ink application changing significantly depending on the moisture content of the recording medium S in this way, the aggregation property of the chromatic color ink varies significantly, which makes it difficult to stably perform high image quality recording. On the other hand, in the present embodiment, by performing control for stabilizing the moisture content and temperature of the recording medium S during recording, changes in the amount of reaction liquid that remains on the recording medium S are suppressed and thus the aggregation property of the chromatic color ink is maintained within an appropriate range to thereby enable stable performance of high image quality recording.

Note that, although in the second embodiment the environmental humidity of the recording unit 7b that is a measurement result obtained by the measurement unit 60 is fed back, a measured value with respect to the recording environment is not limited to the environmental humidity, and another value may be used, or a plurality of measured values such as the environmental humidity and environmental temperature inside or around the recording apparatus may be used. By this means, more precise temperature adjustment control can be performed, and high-quality recording can be performed more stably.

Although in the above description an example is described in which recording medium information is input when performing recording, it is also conceivable that a case may arise in which a recording medium S that has not been registered in the recording apparatus 100 is used. In such a case, other means may be adopted such as having the user select similar recording medium information, having the user input only information indicating whether the recording medium S is permeable or non-permeable, or having the user select whether or not to perform temperature adjustment control based on information from the measurement unit 60.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure it is possible to control the temperature of a recording medium based on a recording environment condition so that the amount of a reaction liquid that reacts with ink on the recording medium is an appropriate amount, to thereby suppress the occurrence of image unevenness and stably perform high-quality recording.

This application claims the benefit of Japanese Patent Application No. 2025-076126, filed May 1, 2025, which is hereby incorporated by reference herein in its entirety.

What is claimed is:

1. A recording apparatus, comprising:
a recording unit configured to record an image on a recording medium by applying ink containing a color material, and a reaction liquid that reacts with the color material,
a first acquiring unit configured to acquire a measurement result of a recording environment condition during recording by the recording unit, and
a temperature adjustment unit configured to adjust a temperature of the recording medium based on driving settings corresponding to the acquired measurement result.

2. The recording apparatus according to claim 1, wherein:
the recording environment condition includes at least one of a temperature of the recording medium, a moisture content of the recording medium, an environmental temperature inside or around the recording apparatus, and an environmental humidity inside or around the recording apparatus.

3. The recording apparatus according to claim 1, further comprising:
a second acquiring unit configured to acquire information relating to permeability of the recording medium;
wherein:
the temperature adjustment unit adjusts the temperature of the recording medium based on the measurement result and the permeability of the recording medium.

4. The recording apparatus according to claim 3, wherein:
if the recording medium does not have low permeability to the reaction liquid, the temperature adjustment unit does not perform adjustment of the temperature of the recording medium.

5. The recording apparatus according to claim 1, wherein:
the measurement unit measures the temperature of the recording medium as the recording environment condition, and
if the temperature of the recording medium is equal to or less than a first threshold value, the temperature adjustment unit heats the recording medium at a higher temperature than in a case where the temperature of the recording medium exceeds the first threshold value, and if the temperature of the recording medium exceeds a second threshold value that is higher than the first threshold value, the temperature adjustment unit cools the recording medium.

6. The recording apparatus according to claim 1, wherein:
the measurement unit measures an environmental humidity inside or around the recording apparatus or a moisture content of the recording medium as the recording environment condition, and
if the environmental humidity or the moisture content of the recording medium is equal to or greater than a third threshold value, the temperature adjustment unit heats the recording medium at a higher temperature than in a case where the environmental humidity or the moisture content of the recording medium is less than the third threshold value, and if the environmental humidity or the moisture content of the recording medium is less than a fourth threshold value that is lower than the third threshold value, the temperature adjustment unit cools the recording medium.

7. The recording apparatus according to claim 1, wherein:
the recording unit includes a first recording unit for applying white ink and a reaction liquid for the white ink, and a second recording unit for applying chromatic color ink and a reaction liquid for chromatic color ink, and
the temperature adjustment unit includes a heating unit and a cooling unit for drying the white ink and the reaction liquid for the white ink that are applied to the recording medium, and a decision unit for deciding driving settings for the heating unit and the cooling unit based on the measurement result.

8. The recording apparatus according to claim 7, wherein:
the temperature adjustment unit adjusts the temperature of the recording medium that is conveyed to the second recording unit.

9. The recording apparatus according to claim 7, wherein:
the white ink and the reaction liquid for the white ink are not applied using the first recording unit.

10. The recording apparatus according to claim 1, wherein:
the temperature adjustment unit adjusts the temperature of the recording medium so that an amount of the reaction liquid remaining on a surface of the recording medium when the ink is applied is a suitable amount for aggregating the ink.

11. The recording apparatus according to claim 1, further comprising:
a measurement unit configured to measure a recording environment condition during recording by the recording unit,
wherein:
the first acquiring unit acquires the measurement result from the measurement unit.

12. A recording method, having:
a step of recording an image on a recording medium by applying ink containing a color material, and a reaction liquid that reacts with the color material in a recording apparatus,
a step of acquiring a measurement result of a recording environment condition in the step of recording, and
a step of adjusting a temperature of the recording medium based on driving settings corresponding to a measurement result acquired by the step of acquiring.

13. A non-transitory computer readable storage medium storing a program for causing a computer to perform an information processing method comprising:
a step of recording an image on a recording medium by applying ink containing a color material, and a reaction liquid that reacts with the color material in a recording apparatus,
a step of acquiring a measurement result of a recording environment condition in the step of recording, and
a step of adjusting a temperature of the recording medium based on driving settings corresponding to a measurement result acquired by the step of acquiring.
